(19) United States
(12) Patent Application Publication
(10) Pub. No.: US 2025/0297792 A1
(43) Pub. Date: Sep. 25, 2025

(54) VAPOR CYCLE REFRIGERATION SYSTEM, AIRCRAFT GALLEY UNIT, AIRCRAFT GALLEY AND AIRCRAFT

(71) Applicant: Airbus Operations GmbH, HAMBURG (DE)

(72) Inventor: Torsten TRÜMPER, HAMBURG (DE)

(21) Appl. No.: 19/085,660

(22) Filed: Mar. 20, 2025

(30) Foreign Application Priority Data
Mar. 22, 2024 (EP) 24165469.8

(51) Int. Cl. F25B 49/00; B64D 11/04

(52) U.S. Cl. CPC F25B 49/005; B64D 11/04

(57) ABSTRACT

A vapor cycle refrigeration system comprising a closed loop refrigerant piping for circulating a refrigerant, and a hermetically sealed housing with an internal space. The entire piping is accommodated within the housing such that leakage from the piping leads into the internal space instead of an atmosphere surrounding the housing. Also an aircraft galley unit, aircraft galley, and aircraft with such a vapor cycle refrigeration system.

### CROSS-REFERENCES TO RELATED APPLICATIONS

This application claims the benefit of European Patent Application Number 24165469.8 filed on Mar. 22, 2024, the entire disclosure of which is incorporated herein by way of reference.

### FIELD OF THE INVENTION

The invention is directed towards a vapor cycle refrigeration system. The invention is further directed towards an aircraft galley unit comprising the vapor cycle refrigeration system, an aircraft galley comprising the aircraft galley unit, and an aircraft comprising the aircraft galley unit and/or the aircraft galley.

### BACKGROUND OF THE INVENTION

Currently, vapor cycle refrigeration systems for cooling air in an aircraft use A1 class refrigerants, which have no flame propagation, i.e. have low flammability, which is indicated by the number “1”, and no identified toxicity at concentrations at or below 400 ppm, i.e. have low toxicity, which is indicated by the letter “A”. The refrigerant safety class referred to here is based on the ASHRAE Standard 34. Due to the EU F-Gas regulation, A3 class refrigerants will be used in the future, which—as indicated by the higher number “3”—have higher flammability than A1 class refrigerants. Future-proof refrigerants consist mainly of hydrocarbons (A3) with the exception of CO₂ (A1), which has a high-pressure level, or ammonia (B3).

### SUMMARY OF THE INVENTION

A problem to be solved is to provide a vapor cycle refrigeration system with increased safety for operation with refrigerants that are more dangerous, e.g. more flammable and/or more toxic, than with the ones currently being used in an aircraft, e.g. A1 class refrigerants.

The problem may be solved by one or more embodiments described herein.

The solution aids in attempting to prevent dangerous amounts of refrigerant leakage into the atmosphere surrounding the vapor cycle refrigeration system, e.g. into an aircraft cabin.

The problem underlaying the invention may be particularly solved by the following:

[1] Vapor cycle refrigeration system, comprising: a closed loop refrigerant piping for circulating a refrigerant; and a hermetically sealed housing with an internal space, wherein the housing is optionally configured to remain hermetically sealed at an internal pressure of up to 4 bar; wherein the entire piping is accommodated within the housing such that leakage of the piping leads into the internal space instead of the atmosphere surrounding the housing.

[2] Vapor cycle refrigeration system according to section [1], wherein the internal space comprises an inert gas, optionally nitrogen.

[3] Vapor cycle refrigeration system according to section [1] or [2], wherein the housing comprises a pressure relieve unit, optionally a burst disk or safety valve, for relieving pressure from the internal space to the atmosphere surrounding the housing, wherein the pressure relieve unit is optionally configured to relieve an internal pressure of equal to or more than an allowable pressure inside the housing 5, e.g. 4 bar.

[4] Vapor cycle refrigeration system according to section [3], wherein the pressure relieve unit comprises a filter cartridge for capturing refrigerant from the internal space upon pressure relieve, wherein the filter cartridge is optionally filled with active coal or silica gel.

[5] Vapor cycle refrigeration system according to any one of sections [1] to [4], wherein the housing comprises at least one wall, which comprises an inner surface defining the internal space and an outer surface contacting the atmosphere surrounding the housing, and in which at least a portion of the piping is integrated, wherein the wall is optionally covered with an insulation, and wherein the housing optionally comprises at least one fan configured to create an airflow along the outer surface. The wall with the integrated piping may also be referred to as a cold plate.

[6] Vapor cycle refrigeration system according to any one of sections [1] to [5], wherein the housing comprises a pressure sensor that is configured to detect a pressure and/or a change in the pressure in the internal space.

[7] Vapor cycle refrigeration system according to any one of sections [1] to [6], wherein the piping comprises a flammable and/or toxic refrigerant, optionally an A3 class refrigerant.

[8] Aircraft galley unit comprising the vapor cycle refrigeration system according to any one of sections [1] to [7].

[9] Aircraft galley comprising the aircraft galley unit according to section [8].

[10] Aircraft comprising the aircraft galley unit according to section [8] and/or the aircraft galley according to section [9].

### BRIEF DESCRIPTION OF THE DRAWINGS

The foregoing summary, as well as the following detailed description, will be better understood when read in conjunction with the appended drawings. For the purposes of illustrating the present disclosure, preferred embodiments are shown in the drawings. It should be understood, however, that the invention is not limited to the specific embodiments disclosed, and reference is made to the claims for that purpose. In the drawings:

FIG. 1 shows a side cross-section view of a vapor cycle refrigeration system according to the invention; and

FIG. 2 shows a top view of an aircraft with the location of an aircraft galley therein, which may comprise the vapor cycle refrigeration system.

### DETAILED DESCRIPTION OF THE PREFERRED EMBODIMENTS

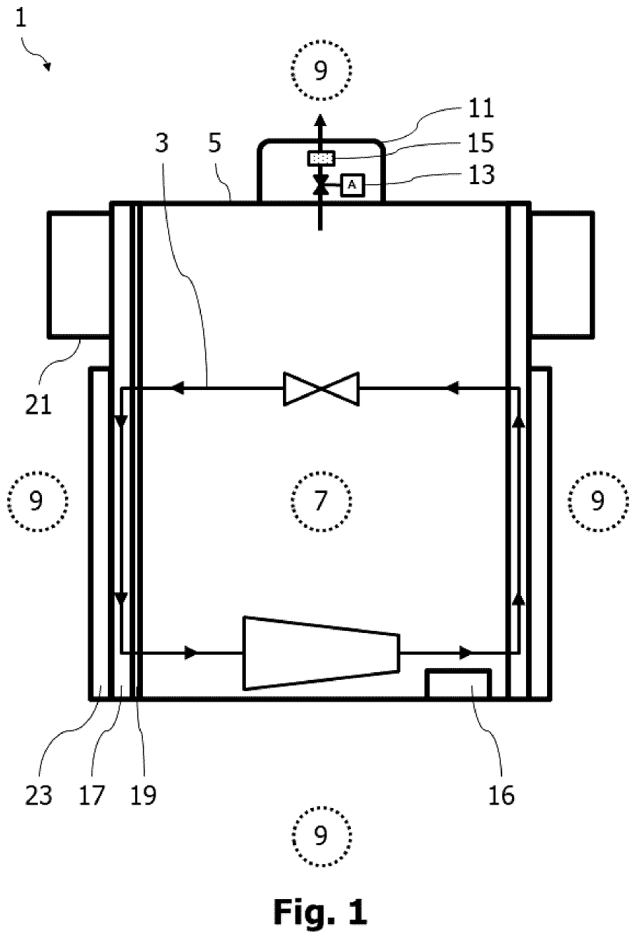

FIG. 1 shows a side cross-section view of a vapor cycle refrigeration system 1 according to the invention.

The vapor cycle refrigeration system 1 comprises a closed loop refrigerant piping 3, which is hermetically sealed and in which a refrigerant is circulated. Here, the piping comprises a flammable refrigerant, e.g., an A3 class refrigerant.

The vapor cycle refrigeration system 1 further comprises a hermetically sealed housing 5 with an internal space 7, wherein the housing 5 is configured to remain hermetically sealed at an internal pressure of up to 4 bar. It can already be seen that the entire piping 3 is accommodated within the housing 5 such that leakage of the piping 3 leads into the internal space 7 instead of the atmosphere 9 surrounding the housing 5. Optionally, the amount of refrigerant in the piping 3 is configured to be such that leakage of the piping 3 leads to a rise in the internal pressure to a value at which the housing 5 still remains hermetically sealed, e.g. to a value of 2, 3 or 4 bar, e.g. at room temperature. This can be achieved by providing the piping 3 entirely within the internal space 7, or always closer to the internal space 7 than to the atmosphere 9 surrounding the housing 5. An alternative or additional provision to the latter may be that any portion of the piping 3 is distanced from the atmosphere 9 surrounding the housing 5 by material of the housing 5 that is stronger, i.e. more pressure resistant, than material of the housing 5 distancing the piping 3 from the internal space 7 at the exact same portion. Here, the internal space 7 comprises an inert gas, which in this case is nitrogen. In case refrigerant leaks from the piping 3 into the internal space 7, the inert gas reduces the refrigerants flammability. Optionally, the amount of inert gas in the internal space 7 is configured dependent on the amount of refrigerant in the piping 3 such that leakage of the piping 3 leads to gas mixture with a reduced flammability, e.g. a flammability that is reduced to the level of A1 class refrigerants.

Further, the housing 5 comprises a pressure relieve unit 11, which can comprise a burst disk or—as in this case—a safety valve 13, configured to automatically relieve pressure from the internal space 7 to the atmosphere 9 surrounding the housing 5, wherein the pressure relieve unit 11 may be configured to relieve an internal pressure of equal to or more than an allowable pressure inside the housing 5, e.g. 4 bar, as is the case in this example. Here, the pressure relieve unit 11 additionally comprises a filter cartridge 15 for capturing refrigerant from the internal space 7 upon pressure relieve, wherein the filter cartridge 15 is filled with active coal, silica gel or any other material capable of capturing hydrocarbon components. As shown, all of the gas inside the internal space 7 has to pass the pressure relieve unit 11 to reach the atmosphere 9 surrounding the housing 5. The filter cartridge 15 is configured such that it helps avoid a dangerous, i.e. flammable and/or toxic, atmosphere 9 surrounding the housing 5, when leakage from the piping 3 into the internal space 7 causes a built-up of internal pressure and subsequent pressure relieve through the pressure relieve unit 11. Optionally, the amount of active coal, silica gel or any other material capable of capturing hydrocarbon components is configured dependent on the amount of refrigerant in the piping 3 and the amount of inert gas, if any such inert gas is provided in the internal space 7, such that the gas mixture reaching the atmosphere 9 through the pressure relieve unit 11 has a reduced flammability, e.g. a flammability that is reduced to the level of A1 class refrigerants. In particular, the amount of active coal, silica gel or any other material capable of capturing hydrocarbon components may be in the range from 10 g to 40 g.

The housing 5 may further comprise a pressure sensor 16 that is configured to detect a pressure and/or a change in the pressure in the internal space 7, i.e. the internal pressure. The pressure sensor 16 may be configured to indicate the internal pressure and/or change in the internal pressure to the outside of the housing 5, i.e. the side of the housing 5 in contact with the atmosphere 9. Once the internal pressure and/or the change in the internal pressure has exceeded a predetermined threshold value, a temporary or permanent indication of malfunction of the housing 5 may be displayed to the outside of the housing 5. A permanent display of malfunction may be provided by a one-way indicator of internal pressure and/or change in the internal pressure. In other words, even if the internal pressure and/or change in the internal pressure occurs only for a short period of time to then return to an initial, normal state, e.g. a constant internal pressure within the range from 0 to 1 bar, the highest/lowest value of the internal pressure and/or change in the internal pressure will still be displayed. This helps avoid the use or re-use of a defective vapor cycle refrigeration system 1, which on first glance from the outside may not seem to be defective.

Here, the housing 5 comprises at least one wall 17, which comprises an inner surface defining the internal space 7 and an outer surface contacting the atmosphere 9 surrounding the housing 5, and in which at least a portion of the piping 3 is integrated, wherein the wall 17 is optionally covered with an insulation 19, and wherein the housing 5 optionally comprises at least one fan 21 configured to create an airflow along the outer surface. Fins 23, which are in thermal contact with the piping 3, either directly or indirectly via the wall 17, and which extend beyond the wall 17 into the atmosphere 9 surrounding the housing 5 are located to extend partially or entirely in the direction of the airflow created by the at least one fan 21.

An aircraft galley unit, e.g. an aircraft galley trolley, an aircraft galley compartment, or an aircraft galley compartment insert, may comprise the vapor cycle refrigeration system 1.

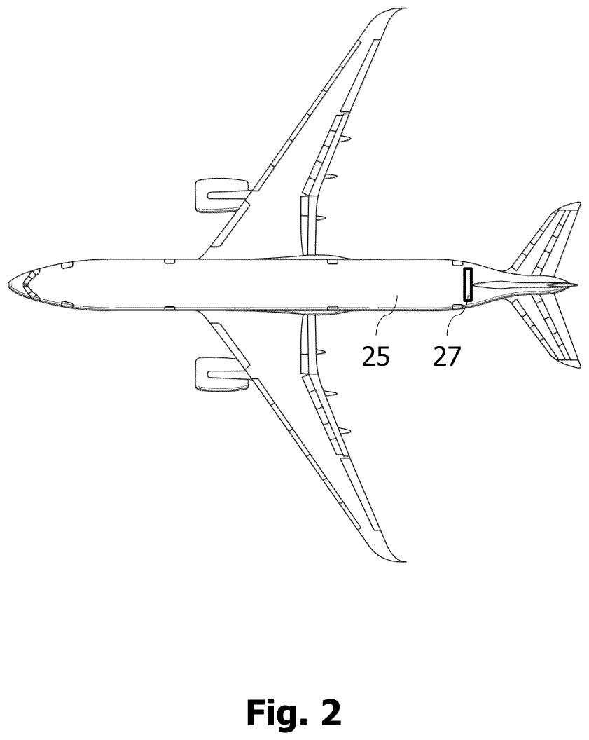

FIG. 2 shows a top view of an aircraft 25 with the location of an aircraft galley 27 therein.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A vapor cycle refrigeration system, comprising:
a closed loop refrigerant piping for circulating a refrigerant; and
a hermetically sealed housing with an internal space;
wherein an entirety of the closed loop refrigerant piping is accommodated within the housing such that leakage of the closed loop refrigerant piping leads into the internal space instead of an atmosphere surrounding the housing.

2. The vapor cycle refrigeration system according to claim 1, wherein the internal space comprises an inert gas.

3. The vapor cycle refrigeration system according to claim 1, wherein the housing comprises a pressure relieve unit for relieving pressure from the internal space to the atmosphere surrounding the housing.

4. The vapor cycle refrigeration system according to claim 3, wherein the pressure relieve unit comprises a filter cartridge for capturing refrigerant from the internal space upon pressure relief.

5. The vapor cycle refrigeration system according to claim 1, wherein the housing comprises at least one wall which comprises an inner surface defining the internal space and an outer surface contacting the atmosphere surrounding the housing, and
wherein at least a portion of the closed loop refrigerant piping is integrated in the at least one wall.

6. The vapor cycle refrigeration system according to claim 1, wherein the housing comprises a pressure sensor configured to detect a pressure in the internal space, or a change in a pressure in the internal space, or both.

7. The vapor cycle refrigeration system according to claim 1, wherein the closed loop refrigerant piping comprises a flammable refrigerant, or a toxic refrigerant, or both.

8. An aircraft galley unit comprising:
the vapor cycle refrigeration system according to claim 1.

9. An aircraft galley comprising:
the aircraft galley unit according to claim 8.

10. An aircraft comprising:
the aircraft galley unit according to claim 8.
